(19) United States
(12) Patent Application Publication
(10) Pub. No.: US 2024/0243442 A1
(43) Pub. Date: Jul. 18, 2024

(54) MULTI-LAYERED RIBBON BOND WIRE

(71) Applicant: Atieva, Inc., Newark, CA (US)

(72) Inventors: DodgieReigh M. Calpito, Fairfield, CA (US); Gregory Tzermias, San Francisco, CA (US)

(21) Appl. No.: 18/558,890

(22) PCT Filed: May 3, 2022
(86) PCT No.: PCT/US2022/072075

§ 371 Date: Nov. 3, 2023

Related U.S. Application Data
(60) Provisional application No. 63/201,544, filed on May 4, 2021.

(51) Int. Cl. H01M 50/526; H01M 50/503; H01M 50/505; H01M 50/514; H01M 50/522

(52) U.S. Cl. CPC H01M 50/526; H01M 50/503; H01M 50/505; H01M 50/514; H01M 50/522

(57) ABSTRACT

A battery module comprises: a plurality of electrochemical cells, each electrochemical cell of the plurality of electrochemical cells having a terminal at an end of the cell; a busbar to couple the plurality of electrochemical cells in one of a parallel connection, a series connection, or a parallel and series connection; and a multi-layered ribbon bond wire that connects the terminal of at least one of the plurality of electrochemical cells to the busbar, the multi-layered ribbon bond wire comprising a first layer including a first material, and a second layer including a second material, wherein the second material is different from the first material, wherein the first layer and the second layer are joined to each other, and wherein the first layer contacts the terminal and the busbar.

### CROSS-REFERENCE TO RELATED APPLICATION

This application claims priority to U.S. Patent Application No. 63/201,544, filed on May 4, 2021, and entitled “Multi-Layered Ribbon Bond Wire,” the disclosure of which is incorporated by reference herein in its entirety.

### TECHNICAL FIELD

This document relates to a multi-layered ribbon bond wire.

### BACKGROUND

In recent years, the world's transportation has begun a transition away from powertrains primarily driven by fossil fuels and toward more sustainable energy sources, chiefly among them electric motors powered by on-board energy storages. Vehicle makers are striving to increase efficiency and utility of such vehicles, including the performance of energy storages such as battery packs.

### SUMMARY

In a first aspect, a battery module comprises: a plurality of electrochemical cells, each electrochemical cell of the plurality of electrochemical cells having a terminal at an end of the cell; a busbar to couple the plurality of electrochemical cells in one of a parallel connection, a series connection, or a parallel and series connection; and a multi-layered ribbon bond wire that connects the terminal of at least one of the plurality of electrochemical cells to the busbar, the multi-layered ribbon bond wire comprising a first layer including a first material, and a second layer including a second material, wherein the second material is different from the first material, wherein the first layer and the second layer are joined to each other, and wherein the first layer contacts the terminal and the busbar.

Implementations can include any or all of the following features. The end of the at least one of the plurality of electrochemical cells includes a rim, and wherein the rim is the terminal. The terminal comprises a negative terminal of the at least one of the plurality of electrochemical cells. The first material includes at least one of aluminum or gold. The second material includes copper. The first and second layers are swaged together in the multi-layered ribbon bond wire. The second material has higher conductivity than the first material, and wherein the first material is softer than the second material. The multi-layered ribbon bond wire further comprises a third layer including a third material, wherein the second layer is located between the first and third layers, and wherein the third material is different from the first and second materials. The first material includes at least one of aluminum or gold, wherein the second material includes copper, and wherein the third material includes at least one of a polymer, palladium, platinum, gold, or nickel. The first layer is a coating of the second layer. The multi-layered ribbon bond wire further comprises a third layer including a third material, wherein the third material is different from the first and second materials, and wherein the third material is a coating of the second material. The third material includes at least one of a polymer, palladium, platinum, gold, or nickel, and wherein the second material includes copper. The first layer has a first width in a direction along the terminal, wherein the second layer has a second width in the direction along the terminal, and wherein the second width is greater than the first width. The first layer has a first thickness perpendicular to the direction along the terminal, wherein the second layer has a second thickness perpendicular to the direction along the terminal, and wherein the second thickness is greater than the first thickness. The multi-layered ribbon bond wire is a bimetallic strip capable of serving as a fuse.

In a second aspect, a method comprises: providing a multi-layered ribbon bond wire, the multi-layered ribbon bond wire comprising a first layer including a first material, and a second layer including a second material, wherein the second material is different from the first material, and wherein the second layer is joined to the first layer; contacting a first portion of the first layer of the multi-layered ribbon bond wire to a terminal of an electrochemical cell; forming a first bond between the multi-layered ribbon bond wire and the terminal at the first portion of the first layer; contacting a second portion of the first layer of the multi-layered ribbon bond wire to a busbar; and forming a second bond between the multi-layered ribbon bond wire and the busbar at the second portion of the first layer.

Implementations can include any or all of the following features. The method further comprises cutting off a remainder of the multi-layered ribbon bond wire after forming the second bond. Forming the first and second bonds comprises using ultrasonic wirebonding. The ultrasonic wirebonding comprises applying vibrations to the multi-layered ribbon bond wire at the second layer or at a third layer of the multi-layered ribbon bond wire. Forming the first and second bonds comprises using laser wirebonding. The laser wirebonding is performed at the second layer or at a third layer of the multi-layered ribbon bond wire.

### BRIEF DESCRIPTION OF DRAWINGS

FIGS. 1A-1B show examples of a multi-layered ribbon bond wire and a bonding operation.

FIGS. 2A-2B show other examples of a multi-layered ribbon bond wire and a bonding operation.

FIGS. 3A-3B show other examples of a multi-layered ribbon bond wire and a bonding operation.

FIG. 4 shows an example of a wire bonder head for a multi-layered ribbon bond wire.

FIG. 5 shows an example of a battery module having multi-layered ribbon bond wires.

FIG. 6 shows an example of a method.

Like reference symbols in the various drawings indicate like elements.

### DETAILED DESCRIPTION

This document describes examples of systems and techniques regarding multi-layered ribbon bond wires. In some implementations, a multi-layered ribbon bond wire can include at least one material (e.g., in one layer) selected to provide good bondability, and another material (e.g., in a separate layer) selected to provide good conductivity. The subject matter described herein can improve the performance of energy storages such as battery modules. For example, the interconnects to individual electrochemical cells can be provided with increased conductivity. The subject matter described herein can improve manufacturing processes for battery modules. In some implementations, the bondability between an interconnect and a terminal of the electrochemical cell can be increased. For example, rather than bonding a copper conductor to a cell terminal, which may involve bonding forces that could damage the cell and lead to electrolyte leakage, a multi-layered ribbon bond wire can feature a layer of another material (e.g., aluminum) that can be bonded with less bonding force.

Examples herein refer to an item including a material. As used herein, a material includes one or more types of matter. A material can include a single element (e.g., gold) or multiple elements (e.g., an alloy). For example, a material that includes aluminum can comprise either pure aluminum, or an aluminum alloy. A material can include a substance consisting of molecules (e.g., a polymer).

Examples herein refer to forming a bond between two or more conductive materials. As used herein, a bond can be formed by any technique that joins the materials so that electric current can flow between them. Ultrasonic wirebonding and/or laser wirebonding can be used, to name just two examples.

Examples herein refer to layers being laminated. As used herein, lamination means to generate a composite material by way of applying pressure, heat, welding, or gluing to two or more layers. For example, application of heat and/or pressure can cause diffusion of at least one of the materials into the other. As another example, an adhesive can be used to attach two or more layer to each other.

Examples herein refer to a layer being painted onto another layer. As used herein, painting means to apply a layer onto a material so that the layer converts to a solid film. For example, the layer being applied can be in liquid form, in liquefiable form, or in mastic form before or during the application. For example, spray painting can use compressed gas to atomize paint particles and direct them toward the other layer.

Examples herein refer to a layer being generated at another layer by chemical vapor deposition. As used herein, chemical vapor deposition includes any of multiple vacuum deposition methods where the other layer is exposed to at least one volatile precursor which reacts and/or decomposes on the surface to form the deposited layer.

Examples herein refer to a layer being generated at another layer by physical vapor deposition. As used herein, physical vapor deposition includes any of multiple vacuum deposition methods where the layer material transitions from a condensed phase to a vapor phase and into a thin film condensed phase.

Examples herein refer to a layer being sputter deposited onto another layer. As used herein, sputter deposition means to bombard the surface of a solid material with particles so as to eject microscopic particles therefrom, and cause the microscopic particles to be deposited onto the other layer. For example, the surface of the solid material can be subjected to a plasma or gas.

Examples herein refer to a layer being a coating of another layer. As used herein, a coating includes any of multiple techniques by which a solid layer or film can be generated at the surface of another material. For example, forming the coating can include lamination, painting, chemical vapor deposition, physical vapor deposition, or sputter deposition.

Examples herein refer to two or more layers being swaged to each other. As used herein, swaging includes any of multiple forging processes where the layers of cold metal are subjected to force by a grooved tool or swage to join them to each other.

Examples herein refer to two or more layers being joined to each other. As used herein, joining can include any known technique of forming a durable attachment between the layers, optionally with one or both of the layers having a coating. In some implementations, layers can be joined by swaging, or by forming a bond between the materials, or by application of heat and/or pressure to the layers, or by forming a coating of one layer at another layer, to name just a few examples.

Examples herein refer to electrochemical cells. As used herein, an electrochemical cell is a device that generates electrical energy from chemical reactions, or uses electrical energy to cause chemical reactions, or both. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrolytic cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples herein refer to a battery module, which is an individual component configured for holding and managing multiple electrochemical cells during charging, storage, and use. The battery module can be intended as the sole power source for one or more loads (e.g., electric motors), or more than one battery module of the same or different type can be used. Two or more battery modules can be implemented in a system separately or as part of a larger energy storage unit. For example, a battery pack can include two or more battery modules of the same or different type. A battery module can include control circuitry for managing the charging, storage, and/or use of electrical energy in the electrochemical cells, or the battery module can be controlled by an external component. For example, a battery management system can be implemented on one or more circuit boards (e.g., a printed circuit board).

Examples herein refer to a busbar, and a battery module can have at least one busbar. The busbar is electrically conductive and is used for conducting electricity to the electrochemical cells when charging, or from the cells when discharging. The busbar is made of an electrically conductive material (e.g., metal) and has suitable dimensions considering the characteristics of the electrochemical cells and the intended use. In some implementations, the busbar comprises aluminum (e.g., an aluminum alloy). A busbar can be planar (e.g., flat) or can have one or more bends, depending on the shape and intended use of the battery module.

Examples herein refer to a top or a bottom. These and similar expressions identify things or aspects in a relative way based on an express or arbitrary notion of perspective. That is, these terms are illustrative only, used for purposes of explanation, and do not necessarily indicate the only possible position, direction, and so on.

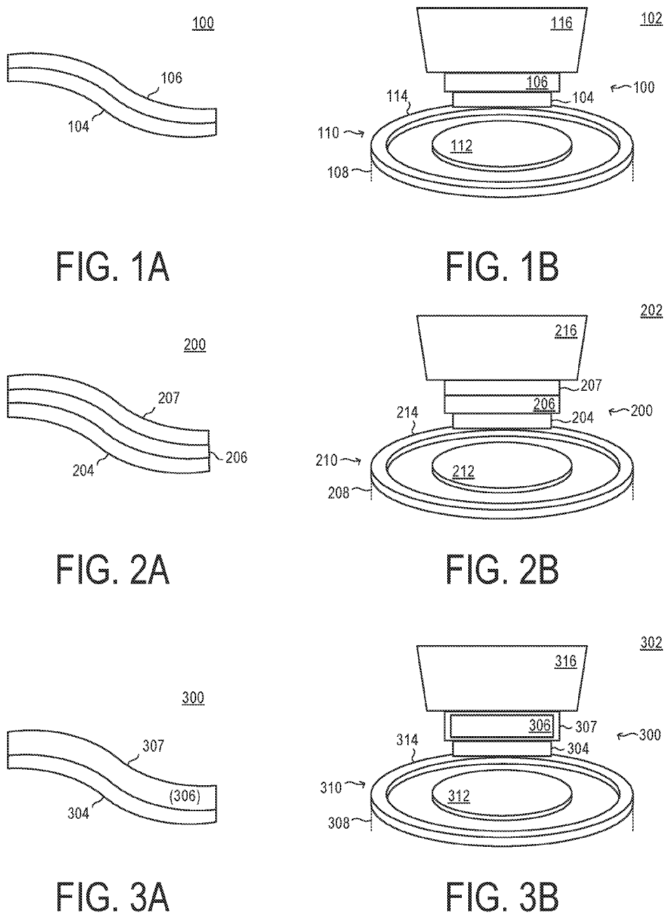

FIGS. 1A-1B show examples of a multi-layered ribbon bond wire 100 and a bonding operation 102. The multi-layered ribbon bond wire 100 and/or the bonding operation 102 can be used with one or more other examples described elsewhere herein.

The multi-layered ribbon bond wire 100 is shown from the side. The multi-layered ribbon bond wire 100 can have a shape suitable for its intended use. In some implementations, the multi-layered ribbon bond wire 100 can be used to form an electrical connection between separate conductive surfaces. For example, the conductive surfaces can be substantially parallel to each other (e.g., co-planar), or the conductive surfaces can be oriented in different directions. As another example, the conductive surfaces can be positioned at substantially the same level relative to a reference level, or the conductive surfaces can be positioned at different levels relative to the reference level. In some implementations, the shape of the multi-layered ribbon bond wire 100 can result from the process by which the multi-layered ribbon bond wire 100 is installed at the two conductive surfaces. For example, the multi-layered ribbon bond wire 100 can initially be kept as stock material on a spool, and a suitable length of the multi-layered ribbon bond wire 100 can be installed, thereby assuming a different shape.

The multi-layered ribbon bond wire 100 includes a layer 104. The layer 104 can extend along at least part of the length of the multi-layered ribbon bond wire 100. For example, the layer 104 can have a substantially rectangular cross section along the length of the multi-layered ribbon bond wire 100. The layer 104 can include a first material. In some implementations, the first material of the layer 104 can be selected to contribute at least characteristics of relatively greater wire bondability to the multi-layered ribbon bond wire 100. For example, the first material can include aluminum and/or gold.

The multi-layered ribbon bond wire 100 includes a layer 106. The layer 106 can extend along at least part of the length of the multi-layered ribbon bond wire 100. For example, the layer 106 can have a substantially rectangular cross section along the length of the multi-layered ribbon bond wire 100. The layer 106 can include a second material. The second material can be different than the first material of the layer 104. In some implementations, the second material of the layer 106 can be selected to contribute at least characteristics of relatively greater conductivity to the multi-layered ribbon bond wire 100. For example, the second material can include copper. The second material can have higher conductivity than the first material. The first material can be softer than the second material. The layer 104 and the layer 106 are joined to each other. For example, current that flows into the first material of the layer 104 can continue to flow into the second material of the layer 106. In some implementations, the layer 104 is a coating of the layer 106.

The bonding operation 102 involves electrically bonding the multi-layered ribbon bond wire 100 to a portion of an electrochemical cell 108. Here, only an end 110 of the electrochemical cell 108 is shown for simplicity. In some implementations, the end 110 can be referred to as a top of the electrochemical cell 108. For example, the electrochemical cell 108 can include a can (not shown) to hold active materials, and the end 110 can be formed by a cap that seals an opening of the can.

The electrochemical cell 108 can have multiple terminals. Here, a terminal 112 is shown as a structure positioned at a center of the end 110. For example, the terminal 112 can be a positive terminal of the electrochemical cell 108. Here, a rim 114 is at least a part of another terminal of the electrochemical cell 108. For example, the rim 114 (and a remainder of the can material, including a bottom of the can) may serve as a negative terminal of the electrochemical cell 108.

The bonding operation 102 can include use of one or more tools. In some implementations, a wire bonding head can be used. A wire bonding head can include a wedge 116. The wedge 116 can be used to bond the multi-layered ribbon bond wire 100 to the rim 114. For example, the wedge 116 can be made of metal. In some implementations, the wedge 116 can apply high-frequency vibrations to the multi-layered ribbon bond wire 100 at the layer 106, such that at least the first material of the layer 104 bonds with material of the rim 114. For example, the rim 114 can include steel or another metal. In some implementations, any other technique for bonding the first material of the layer 104 with the material of the rim 114 can be used.

The layers 104 and 106 can have the same widths as each other, or can be of different width. Here, the layer 104 has a certain width in a direction along the rim 114. Moreover, the layer 106 has another width in the direction along the rim 114 that is greater than the width of the layer 104. A relationship between the widths can be about 1:1.5, or 1:2, to name just two examples. Other proportions can be used. The multi-layered ribbon bond wire 100 can have any orientation relative to the rim 114. In some implementations, as shown, the orientation can be substantially radial. For example, the end of the multi-layered ribbon bond wire 100 is viewed head-on in the illustration of the bonding operation 102. In other implementations, the multi-layered ribbon bond wire 100 can be oriented substantially in a tangential direction relative to the rim 114. Other orientations can be used.

The layers 104 and 106 can have the same thickness as each other, or can be of different thicknesses. Here, the layer 104 has a certain thickness perpendicular to the direction along the rim 114. Moreover, the layer 106 has another thickness perpendicular to the direction along the rim 114 that is greater than the thickness of the layer 104. Other proportions can be used.

FIGS. 2A-2B show other examples of a multi-layered ribbon bond wire 200 and a bonding operation 202. The multi-layered ribbon bond wire 200 and/or the bonding operation 202 can be used with one or more other examples described elsewhere herein.

The multi-layered ribbon bond wire 200 is shown from the side. The multi-layered ribbon bond wire 200 can have a shape suitable for its intended use. In some implementations, the multi-layered ribbon bond wire 200 can be used to form an electrical connection between separate conductive surfaces. For example, the conductive surfaces can be substantially parallel to each other (e.g., co-planar), or the conductive surfaces can be oriented in different directions. As another example, the conductive surfaces can be positioned at substantially the same level relative to a reference level, or the conductive surfaces can be positioned at different levels relative to the reference level. In some implementations, the shape of the multi-layered ribbon bond wire 200 can result from the process by which the multi-layered ribbon bond wire 200 is installed at the two conductive surfaces. For example, the multi-layered ribbon bond wire 200 can initially be kept as stock material on a spool, and a suitable length of the multi-layered ribbon bond wire 200 can be installed, thereby assuming a different shape.

The multi-layered ribbon bond wire 200 includes a layer 204. The layer 204 can extend along at least part of the length of the multi-layered ribbon bond wire 200. For example, the layer 204 can have a substantially rectangular cross section along the length of the multi-layered ribbon bond wire 200. The layer 204 can include a first material. In some implementations, the first material of the layer 204 can be selected to contribute at least characteristics of relatively greater wire bondability to the multi-layered ribbon bond wire 200. For example, the first material can include aluminum and/or gold.

The multi-layered ribbon bond wire 200 includes a layer 206. The layer 206 can extend along at least part of the length of the multi-layered ribbon bond wire 200. For example, the layer 206 can have a substantially rectangular cross section along the length of the multi-layered ribbon bond wire 200. The layer 206 can include a second material. The second material can be different than the first material of the layer 204. In some implementations, the second material of the layer 206 can be selected to contribute at least characteristics of relatively greater conductivity to the multi-layered ribbon bond wire 200. For example, the second material can include copper. The second material can have higher conductivity than the first material. The first material can be softer than the second material. The first layer and the second layer are joined to each other. For example, current that flows into the first material of the layer 204 can continue to flow into the second material of the layer 206. In some implementations, the layer 204 is a coating of the layer 206.

The multi-layered ribbon bond wire 200 includes a layer 207. The layer 206 is located between the layers 204 and 207. The layer 207 can extend along at least part of the length of the multi-layered ribbon bond wire 200. For example, the layer 207 can have a substantially rectangular cross section along the length of the multi-layered ribbon bond wire 200. The layer 207 can include a third material. The third material can be different than the first material of the layer 204 and the second material of the layer 206. In some implementations, the third material of the layer 207 can be selected to contribute at least characteristics of relatively greater corrosion resistance to the multi-layered ribbon bond wire 200. For example, the third material can include at least one material of polymer, palladium, platinum, gold, or nickel. The layer 207 can be a coating of the layer 206.

The bonding operation 202 involves electrically bonding the multi-layered ribbon bond wire 200 to a portion of an electrochemical cell 208. Here, only an end 210 of the electrochemical cell 208 is shown for simplicity. In some implementations, the end 210 can be referred to as a top of the electrochemical cell 208. For example, the electrochemical cell 208 can include a can (not shown) to hold active materials, and the end 210 can be formed by a cap that seals an opening of the can.

The electrochemical cell 208 can have multiple terminals. Here, a terminal 212 is shown as a structure positioned at a center of the end 210. For example, the terminal 212 can be a positive terminal of the electrochemical cell 208. Here, a rim 214 is at least a part of another terminal of the electrochemical cell 208. For example, the rim 214 (and a remainder of the can material, including a bottom of the can) may serve as a negative terminal of the electrochemical cell 208.

The bonding operation 202 can include use of one or more tools. In some implementations, a wire bonding head can be used. A wire bonding head can include a wedge 216. The wedge 216 can be used to bond the multi-layered ribbon bond wire 200 to the rim 214. For example, the wedge 216 can be made of metal. In some implementations, the wedge 216 can apply high-frequency vibrations to the multi-layered ribbon bond wire 200 at the layer 207, such that at least the first material of the layer 204 bonds with material of the rim 214. For example, the rim 214 can include steel or another metal. In some implementations, any other technique for bonding the first material of the layer 204 with the material of the rim 214 can be used.

The layers 204, 206, and 207 can have the same widths as each other, or can be of different width. Here, the layer 204 has a certain width in a direction along the rim 214. Moreover, the layer 206 has another width in the direction along the rim 214 that is greater than the width of the layer 204. A relationship between the widths can be about 1:1.5, or 1:2, to name just two examples. Other proportions can be used. The layer 207 can have about the same width as the layer 206, to name just one example. The multi-layered ribbon bond wire 200 can have any orientation relative to the rim 214. In some implementations, as shown, the orientation can be substantially radial. For example, the end of the multi-layered ribbon bond wire 200 is viewed head-on in the illustration of the bonding operation 202. In other implementations, the multi-layered ribbon bond wire 200 can be oriented substantially in a tangential direction relative to the rim 214. Other orientations can be used.

The layers 204, 206, and 207 can have the same thickness as each other, or can be of different thicknesses. Here, the layer 204 has a certain thickness perpendicular to the direction along the rim 214. Moreover, the layer 206 has another thickness perpendicular to the direction along the rim 214 that is greater than the thickness of the layer 204. The layer 207 can be thicker than, about equal to, or thinner than, the layer 206. Other proportions between the layers 204, 206, and 207 can be used.

Two or more of the layers mentioned in any of the examples described herein can be characterized as a bimetallic strip, and/or can act as a bimetallic thermostat under at least some circumstances. In some implementations, a first metal (including, but not limited to, copper) can have different thermal expansion properties (e.g., a coefficient of thermal expansion) than a second metal (including, but not limited to, aluminum). When the multi-layered ribbon bond wire 200 is subject to heating, this can cause bending in a direction away from one of the materials. In some implementations, when heating occurs as a result of an overcurrent flowing through the multi-layered ribbon bond wire 200, such bending can sever the circuit (e.g., as a fuse) and therefore interrupt further current from flowing. As such, the multi-layered ribbon bond wire 200 can include a bimetallic strip capable of serving as a fuse. For example, a copper layer of the multi-layered ribbon bond wire 200 can serve as a fuse that breaks the circuit by bending in a direction away from an aluminum layer thereof.

FIGS. 3A-3B show other examples of a multi-layered ribbon bond wire 300 and a bonding operation 302. The multi-layered ribbon bond wire 300 and/or the bonding operation 302 can be used with one or more other examples described elsewhere herein.

The multi-layered ribbon bond wire 300 is shown from the side. The multi-layered ribbon bond wire 300 can have a shape suitable for its intended use. In some implementations, the multi-layered ribbon bond wire 300 can be used to form an electrical connection between separate conductive surfaces. For example, the conductive surfaces can be substantially parallel to each other (e.g., co-planar), or the conductive surfaces can be oriented in different directions. As another example, the conductive surfaces can be positioned at substantially the same level relative to a reference level, or the conductive surfaces can be positioned at different levels relative to the reference level. In some implementations, the shape of the multi-layered ribbon bond wire 300 can result from the process by which the multi-layered ribbon bond wire 300 is installed at the two conductive surfaces. For example, the multi-layered ribbon bond wire 300 can initially be kept as stock material on a spool, and a suitable length of the multi-layered ribbon bond wire 300 can be installed, thereby assuming a different shape.

The multi-layered ribbon bond wire 300 includes a layer 304. The layer 304 can extend along at least part of the length of the multi-layered ribbon bond wire 300. For example, the layer 304 can have a substantially rectangular cross section along the length of the multi-layered ribbon bond wire 300. The layer 304 can include a first material. In some implementations, the first material of the layer 304 can be selected to contribute at least characteristics of relatively greater wire bondability to the multi-layered ribbon bond wire 300. For example, the first material can include aluminum and/or gold.

The multi-layered ribbon bond wire 300 includes a layer 306. The layer 306 can extend along at least part of the length of the multi-layered ribbon bond wire 300. For example, the layer 306 can have a substantially rectangular cross section along the length of the multi-layered ribbon bond wire 300. The layer 306 can include a second material. The second material can be different than the first material of the layer 304. In some implementations, the second material of the layer 306 can be selected to contribute at least characteristics of relatively greater conductivity to the multi-layered ribbon bond wire 300. For example, the second material can include copper. The second material can have higher conductivity than the first material. The first material can be softer than the second material. The first layer and the second layer are joined to each other. For example, current that flows into the first material of the layer 304 can continue to flow into the second material of the layer 306.

The multi-layered ribbon bond wire 300 includes a layer 307. The layer 306 can be contained within the layer 307. The layer 307 can extend along at least part of the length of the multi-layered ribbon bond wire 300. For example, the layer 307 can have a substantially rectangular cross section along the length of the multi-layered ribbon bond wire 300. The layer 307 can include a third material. The third material can be different than the first material of the layer 304 and the second material of the layer 306. In some implementations, the third material of the layer 307 can be selected to contribute at least characteristics of relatively greater corrosion resistance to the multi-layered ribbon bond wire 300. For example, the third material can include at least one material of polymer, palladium, platinum, gold, or nickel. The layer 307 can be a coating of the layer 306. For example, the layer 307 is here shown as a coating around an entire periphery of the layer 306.

The bonding operation 302 involves electrically bonding the multi-layered ribbon bond wire 300 to a portion of an electrochemical cell 308. Here, only an end 310 of the electrochemical cell 308 is shown for simplicity. In some implementations, the end 310 can be referred to as a top of the electrochemical cell 308. For example, the electrochemical cell 308 can include a can (not shown) to hold active materials, and the end 310 can be formed by a cap that seals an opening of the can.

The electrochemical cell 308 can have multiple terminals. Here, a terminal 312 is shown as a structure positioned at a center of the end 310. For example, the terminal 312 can be a positive terminal of the electrochemical cell 308. Here, a rim 314 is at least a part of another terminal of the electrochemical cell 308. For example, the rim 314 (and a remainder of the can material, including a bottom of the can) may serve as a negative terminal of the electrochemical cell 308.

The bonding operation 302 can include use of one or more tools. In some implementations, a wire bonding head can be used. A wire bonding head can include a wedge 316. The wedge 316 can be used to bond the multi-layered ribbon bond wire 300 to the rim 314. For example, the wedge 316 can be made of metal. In some implementations, the wedge 316 can apply high-frequency vibrations to the multi-layered ribbon bond wire 300 at the layer 307, such that at least the first material of the layer 304 bonds with material of the rim 314. For example, the rim 314 can include steel or another metal. In some implementations, any other technique for bonding the first material of the layer 304 with the material of the rim 314 can be used.

The layers 304 and 306 can have the same widths as each other, or can be of different width. Here, the layer 304 has a certain width in a direction along the rim 314. Moreover, the layer 306 has another width in the direction along the rim 314 that is greater than the width of the layer 304. A relationship between the widths can be about 1:1.5, or 1:2, to name just two examples. Other proportions can be used. The multi-layered ribbon bond wire 300 can have any orientation relative to the rim 314. In some implementations, as shown, the orientation can be substantially radial. For example, the end of the multi-layered ribbon bond wire 300 is viewed head-on in the illustration of the bonding operation 302. In other implementations, the multi-layered ribbon bond wire 300 can be oriented substantially in a tangential direction relative to the rim 314. Other orientations can be used.

The layers 304 and 306 can have the same thickness as each other, or can be of different thicknesses. Here, the layer 304 has a certain thickness perpendicular to the direction along the rim 314. Moreover, the layer 306 has another thickness perpendicular to the direction along the rim 314 that is greater than the thickness of the layer 304. The layer 307 can be thinner than the layers 304 and 306, to name just one example. Other proportions between the layers 304, 306, and 307 can be used.

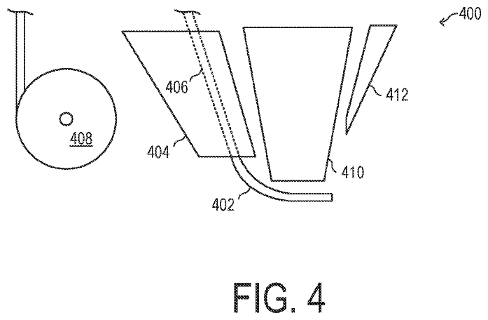

FIG. 4 shows an example of a wire bonder head 400 for a multi-layered ribbon bond wire 402. The wire bonder head 400 and/or the multi-layered ribbon bond wire 402 can be used with one or more other examples described elsewhere herein. The wire bonder head 400 includes a wireguide 404. The wireguide 404 is used for guiding (e.g., feeding) the multi-layered ribbon bond wire 402 in a bonding operation. The wireguide 404 can be made of one or more materials, including, but not limited to, a metal or a synthetic material. A supply 406 of the multi-layered ribbon bond wire 402 is seen as passing through the wireguide 404. In some implementations, the supply 406 of the multi-layered ribbon bond wire 402 can be provided from a spool 408. For example, the spool 408 can be rotatably suspended in relation to the wire bonder head 400 so as to allow the supply 406 of the multi-layered ribbon bond wire 402 to be obtained in a continuous or intermittent fashion, and such that the multi-layered ribbon bond wire 402 has a particular orientation relative to an electrochemical cell for bonding.

The wire bonder head 400 includes a wedge 410. The wedge 410 can be used to bond the multi-layered ribbon bond wire 402 to an electrochemical cell (not shown). For example, the wedge 410 can be made of metal.

The wire bonder head 400 includes a cutter 412. The cutter 412 can be used to sever the multi-layered ribbon bond wire 402 before, during, or after bonding. For example, the cutter 412 can be made of metal.

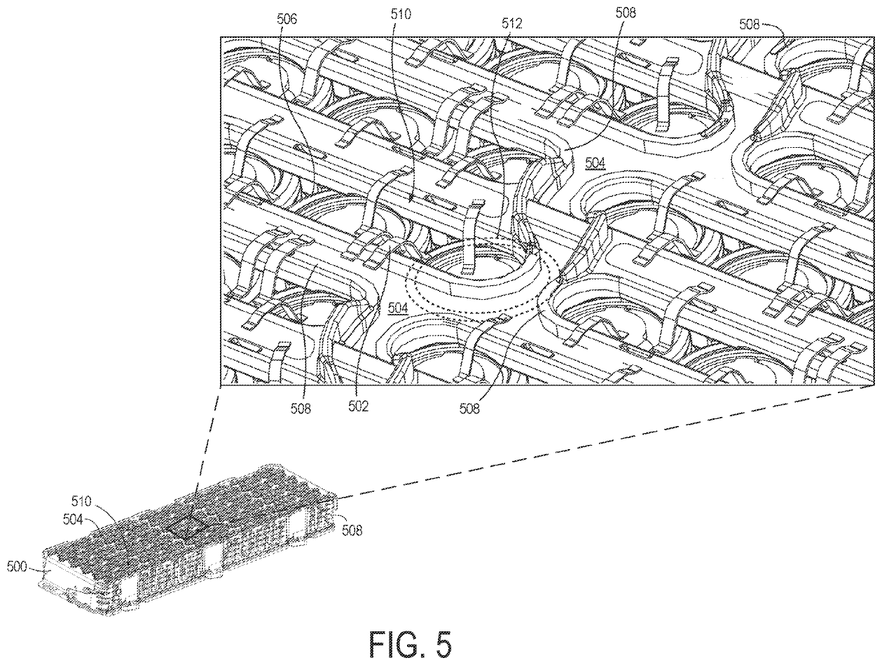

FIG. 5 shows an example of a battery module 500 having multi-layered ribbon bond wires 502. An enlarged portion shows an example of a portion of the battery module 500 in more detail. The battery module 500 and/or the multi-layered ribbon bond wires 502 can be used with one or more other examples described elsewhere herein. The battery module 500 includes a busbar 504. The busbar 504 can be electrically interconnected to a plurality of electrochemical cells 506 contained in the interior of a housing 508 of the battery module 500. In some implementations, the busbar 504 can couple the electrochemical cells 506 in one of a parallel connection, a series connection, or a parallel and series connection. For example, multiple ones of the electrochemical cells 506 can be coupled in parallel into a group, and two or more such groups of electrochemical cells 506 can be coupled in series. The housing 508 has openings 510 into its interior. In some implementations, one or more bonds to terminals of the electrochemical cells 506 can be formed through at least one of the openings 510 (e.g., by way of the multi-layered ribbon bond wires 502). In some implementations, the housing 508 has substantially a prismatic shape, such as an essentially rectilinear shape.

Each of the electrochemical cells 506 includes a terminal 512 that is at least in part positioned around a periphery of one end of the electrochemical cell 506. For example, the terminal 512 can be a negative terminal. For example, the terminal 512 can be a rim of the electrochemical cell 506. The terminal 512 is connected to the busbar 504 by the multi-layered ribbon bond wire 502. The electrochemical cells 506 can have one or more interconnects in addition to the multi-layered ribbon bond wire 502. In some implementations, a conductor can be bonded to the positive terminal of the electrochemical cell 506. For example, such conductor can be a fusing wire.

The battery module 500 is an example of a battery module that includes: a plurality of electrochemical cells (e.g., the electrochemical cells 506), each electrochemical cell of the plurality of electrochemical cells having a terminal (e.g., the terminal 512) at an end of the electrochemical cell; a busbar (e.g., the busbar 504) to couple the plurality of electrochemical cells in one of a parallel connection, a series connection, or a parallel and series connection; and a multi-layered ribbon bond wire (e.g., the multi-layered ribbon bond wire 502) that connects the terminal of at least one of the plurality of electrochemical cells to the busbar, the multi-layered ribbon bond wire comprising a first layer (e.g., the layer 104 (FIGS. 1A-1B), the layer 204 (FIGS. 2A-2B), or the layer 304 (FIGS. 3A-3B)) including a first material, and a second layer (e.g., the layer 106 (FIGS. 1A-1B), the layer 206 (FIGS. 2A-2B), or the layer 306 (FIGS. 3A-3B)) including a second material, wherein the second material is different from the first material, wherein the first layer and the second layer are joined to each other, and wherein the first layer contacts the terminal (e.g., as shown in FIG. 1B, 2B, or 3B) and the busbar (e.g., as shown in FIG. 5).

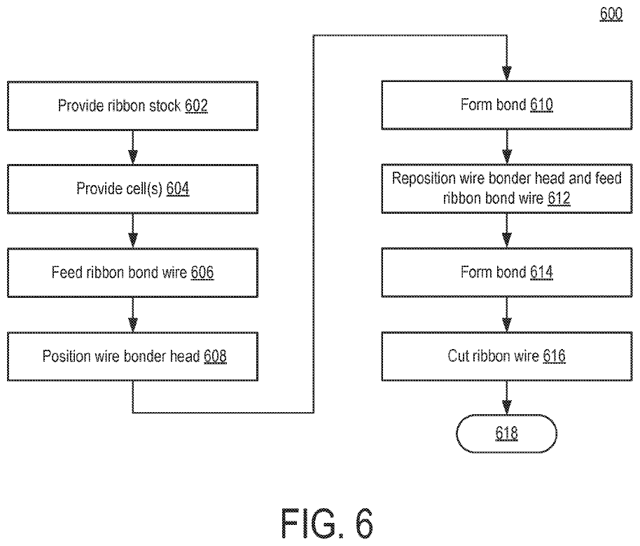

FIG. 6 shows an example of a method 600. The method 600 can be used with one or more other examples described elsewhere herein. More or fewer operations than shown can be performed. Two or more operations can be performed in a different order unless otherwise indicated.

At operation 602, the method 600 can include providing ribbon stock to orient a multi-layered ribbon bond wire relative to a battery module. For example, the spool 408 (FIG. 4) can be provided.

At operation 604, the method 600 can include providing one or more electrochemical cells for the battery module. For example, the electrochemical cells can be provided within a housing of the battery module.

At operation 606, the method 600 can include feeding ribbon bond wire from the ribbon stock. For example, the wireguide 404 can supply the multi-layered ribbon bond wire 402 in FIG. 4.

At operation 608, the method 600 can include positioning a wire bonder head relative to at least one of the electrochemical cells. In some implementations, this involves contacting a first portion of a first layer (e.g., the layer 104 (FIGS. 1A-1B), the layer 204 (FIGS. 2A-2B), or the layer 304 (FIGS. 3A-3B)) of the multi-layered ribbon bond wire to a terminal (e.g., the rim 114 (FIG. 1B), the rim 214 (FIG. 2B), or the rim 314 (FIG. 3B)) of an electrochemical cell.

At operation 610, the method 600 can include forming a first bond (e.g., as shown in FIG. 1B, 2B, or 3B) between the multi-layered ribbon bond wire and the terminal at the first portion of the first layer. In some implementations, ultrasonic wirebonding is used. For example, the ultrasonic wirebonding can include applying vibrations using a wedge (e.g., the wedge 116 in FIG. 1B, the wedge 216 in FIG. 2B, the wedge 316 in FIG. 3B, or the wedge 410 in FIG. 4) to the multi-layered ribbon bond wire at the second layer or at a third layer of the multi-layered ribbon bond wire (e.g., as exemplified in FIG. 1B, 2B, or 3B). In some implementations, laser wirebonding is used. For example, the laser wirebonding can be performed at the second layer (e.g., the layer 106 (FIGS. 1A-1B), the layer 207 (FIGS. 2A-2B), or the layer 307 (FIGS. 3A-3B)) or at a third layer of the multi-layered ribbon bond wire (e.g., as exemplified in FIG. 1B, 2B, or 3B).

At operation 612, the method 600 can include repositioning the wire bonder head and feeding the ribbon bond wire. In some implementations, the wire bonder head can be repositioned to the busbar 504 (FIG. 4). For example, this can involve contacting a second portion of the first layer (e.g., the layer 104 (FIGS. 1A-1B), the layer 204 (FIG. 2A-2B), or the layer 304 (FIGS. 3A-3B)) of the multi-layered ribbon bond wire to a busbar (e.g., the busbar 504 (FIG. 5)). In some implementations, the wireguide 404 can feed the multi-layered ribbon bond wire 402 to a length suitable for the installation.

At operation 614, the method 600 can include forming a second bond (e.g., as shown in FIG. 5) between the multi-layered ribbon bond wire and the busbar at the second portion of the first layer. In some implementations, ultrasonic wirebonding is used. For example, the ultrasonic wirebonding can include applying vibrations using a wedge (e.g., the wedge 116 in FIG. 1B, the wedge 216 in FIG. 2B, the wedge 316 in FIG. 3B, or the wedge 410 in FIG. 4) to the multi-layered ribbon bond wire at the second layer or at a third layer of the multi-layered ribbon bond wire (e.g., as exemplified in FIG. 1B, 2B, or 3B). In some implementations, laser wirebonding is used. For example, the laser wirebonding can be performed at the second layer (e.g., the layer 106 (FIGS. 1A-1B), the layer 207 (FIGS. 2A-2B), or the layer 307 (FIGS. 3A-3B)) or at a third layer of the multi-layered ribbon bond wire (e.g., as exemplified in FIG. 1B, 2B, or 3B).

At operation 616, the method 600 can include cutting the ribbon bond wire. In some implementations, the cutter 412 can be applied (e.g., manually or automatically) to terminate the multi-layered ribbon bond wire 402 in FIG. 4.

At operation 618, zero, one or more operations can be performed. In some implementations, the method 600 can end after performing the operations 602-616. In some implementations, some or all of the operations 602-616 can be performed at the operation(s) 618 regarding another multi-layered ribbon bond wire, and/or regarding another electrochemical cell. In some implementations, another type of interconnect can be formed, additionally to the same electrochemical cell of the operations 602-616, or to another electrochemical cell. For example, such other interconnect can include a fusing wire. Other approaches can be used.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A battery module comprising:
a plurality of electrochemical cells, each electrochemical cell of the plurality of electrochemical cells having a terminal at an end of the cell;
a busbar to couple the plurality of electrochemical cells in one of a parallel connection, a series connection, or a parallel and series connection; and
a multi-layered ribbon bond wire that connects the terminal of at least one of the plurality of electrochemical cells to the busbar, the multi-layered ribbon bond wire comprising a first layer including a first material, and a second layer including a second material, wherein the second material is different from the first material, wherein the first layer and the second layer are joined to each other, and wherein the first layer contacts the terminal and the busbar.

2. The battery module of claim 1, wherein the end of the at least one of the plurality of electrochemical cells includes a rim, and wherein the rim is the terminal.

3. The battery module of claim 1, wherein the terminal comprises a negative terminal of the at least one of the plurality of electrochemical cells.

4. The battery module of claim 1, wherein the first material includes at least one of aluminum or gold.

5. The battery module of claim 1, wherein the second material includes copper.

6. The battery module of claim 1, wherein the first and second layers are swaged together in the multi-layered ribbon bond wire.

7. The battery module of claim 1, wherein the second material has higher conductivity than the first material, and wherein the first material is softer than the second material.

8. The battery module of claim 1, wherein the multi-layered ribbon bond wire further comprises a third layer including a third material, wherein the second layer is located between the first and third layers, and wherein the third material is different from the first and second materials.

9. The battery module of claim 8, wherein the first material includes at least one of aluminum or gold, wherein the second material includes copper, and wherein the third material includes at least one of a polymer, palladium, platinum, gold, or nickel.

10. The battery module of claim 1, wherein the first layer is a coating of the second layer.

11. The battery module of claim 1, wherein the multi-layered ribbon bond wire further comprises a third layer including a third material, wherein the third material is different from the first and second materials, and wherein the third material is a coating of the second material.

12. The battery module of claim 11, wherein the third material includes at least one of a polymer, palladium, platinum, gold, or nickel, and wherein the second material includes copper.

13. The battery module of claim 1, wherein the first layer has a first width in a direction along the terminal, wherein the second layer has a second width in the direction along the terminal, and wherein the second width is greater than the first width.

14. The battery module of claim 13, wherein the first layer has a first thickness perpendicular to the direction along the terminal, wherein the second layer has a second thickness perpendicular to the direction along the terminal, and wherein the second thickness is greater than the first thickness.

15. The battery module of claim 1, wherein the multi-layered ribbon bond wire is a bimetallic strip capable of serving as a fuse.

16. A method comprising:
providing a multi-layered ribbon bond wire, the multi-layered ribbon bond wire comprising a first layer including a first material, and a second layer including a second material, wherein the second material is different from the first material, and wherein the second layer is joined to the first layer;
contacting a first portion of the first layer of the multi-layered ribbon bond wire to a terminal of an electrochemical cell;
forming a first bond between the multi-layered ribbon bond wire and the terminal at the first portion of the first layer;
contacting a second portion of the first layer of the multi-layered ribbon bond wire to a busbar; and
forming a second bond between the multi-layered ribbon bond wire and the busbar at the second portion of the first layer.

17. The method of claim 16, further comprising cutting off a remainder of the multi-layered ribbon bond wire after forming the second bond.

18. The method of claim 16, wherein forming the first and second bonds comprises using ultrasonic wirebonding.

19. The method of claim 18, wherein the ultrasonic wirebonding comprises applying vibrations to the multi-layered ribbon bond wire at the second layer or at a third layer of the multi-layered ribbon bond wire.

20. The method of claim 16, wherein forming the first and second bonds comprises using laser wirebonding.

21. The method of claim 20, wherein the laser wirebonding is performed at the second layer or at a third layer of the multi-layered ribbon bond wire.
